(19) United States
(12) Patent Application Publication
(10) Pub. No.: US 2013/0195350 A1
(43) Pub. Date: Aug. 1, 2013

(54) IMAGE ENCODING DEVICE, IMAGE ENCODING METHOD, IMAGE DECODING DEVICE, IMAGE DECODING METHOD, AND COMPUTER PROGRAM PRODUCT

(71) Applicant: KABUSHIKI KAISHA TOSHIBA, Tokyo (JP)

(72) Inventors: Tatsuya Tanaka, Kanagawa (JP); Nakaba Kogure, Kanagawa (JP); Youhei Fukazawa, Kanagawa (JP); Wataru Asano, Kanagawa (JP); Tomoya Kodama, Kanagawa (JP); Shinichiro Koto, Tokyo (JP)

(73) Assignee: KABUSHIKI KAISHA TOSHIBA, Tokyo (JP)

(21) Appl. No.: 13/826,281

(22) Filed: Mar. 14, 2013

Related U.S. Application Data
(63) Continuation of application No. PCT/JP2011/057782, filed on Mar. 29, 2011.

(51) Int. Cl. G06K 9/00

(52) U.S. Cl. CPC G06K 9/00201
USPC 382/154

(57) ABSTRACT

According to an embodiment, an image encoding device according to an embodiment includes an image generating unit, a first filtering unit, a prediction image generating unit, and an encoding unit. The image generating unit is configured to generate a first parallax image corresponding to a first viewpoint of an image to be encoded, with the use of at least one of depth information and parallax information of a second parallax image corresponding to a second viewpoint being different than the first viewpoint. The first filtering unit is configured to perform filtering on the first parallax image based on first filter information. The prediction image generating unit is configured to generate a prediction image with a reference image, the reference image being the first parallax image on which the filtering has been performed. The encoding unit is configured to generate encoded data from the image and the prediction image.

### CROSS-REFERENCE TO RELATED APPLICATION

This application is a continuation of PCT international Application No. PCT/JP2011/057782, filed on Mar. 29, 2011, which designates the United States; the entire contents of which are incorporated herein by reference.

### FIELD

Embodiments described herein relate generally to an image encoding device, an image encoding method, an image decoding device, an image decoding method, and computer program products.

### BACKGROUND

In a typical multi-image encoding device, an image synthesizing technology is implemented to generate a parallax image at a viewpoint to be encoded from a local decoded image at a different viewpoint than the viewpoint of the image to be encoded, and the parallax image at the synthesized viewpoint is either considered to be a decoded image without modification or used as a prediction image for encoding.

However, in the case when a parallax image that is generated by means of image synthesis is output without modification, the image quality undergoes deterioration. Thus, if a parallax image that is generated by means of image synthesis is used as a prediction image, the error between the parallax image and the original image gets encoded as residual error information. That leads to poor encoding efficiency.

### BRIEF DESCRIPTION OF THE DRAWINGS

FIG. 1 is a diagram illustrating an image encoding device according to a first embodiment;

FIG. 2 is a diagram for explaining an example of encoding according to the first embodiment;

FIG. 3 is a diagram illustrating an example of camera parameters according to the first embodiment;

FIG. 4 is a flowchart for explaining a sequence of operations performed during an encoding process according to the first embodiment;

FIG. 5 is a diagram illustrating an image decoding device according to a second embodiment;

FIG. 6 is a flowchart for explaining a sequence of operations performed during a decoding process according to the second embodiment;

FIG. 7 is a diagram illustrating an image decoding unit according to a third embodiment; and

FIG. 8 is a diagram illustrating an example of encoding multiparallax images according to the third embodiment.

### DETAILED DESCRIPTION

According to an embodiment, an image encoding device according to an embodiment includes an image generating unit, a first filtering unit, a prediction image generating unit, and an encoding unit. The image generating unit is configured to generate a first parallax image corresponding to a first viewpoint of an image to be encoded, with the use of at least one of depth information and parallax information of a second parallax image corresponding to a second viewpoint different than the first viewpoint. The first filtering unit is configured to perform filtering on the first parallax image based on first filter information. The prediction image generating unit is configured to generate a prediction image with a reference image, the reference image being the first parallax image on which the filtering has been performed. The encoding unit is configured to generate encoded data from the image and the prediction image.

### First Embodiment

In a first embodiment, the explanation is given about an image encoding device that implements an image synthesizing technology to generate a parallax image at a viewpoint to be encoded from already-decoded parallax images at a different viewpoint than the viewpoint of the image to be encoded, and the parallax image at the synthesized viewpoint is used as a prediction image for encoding.

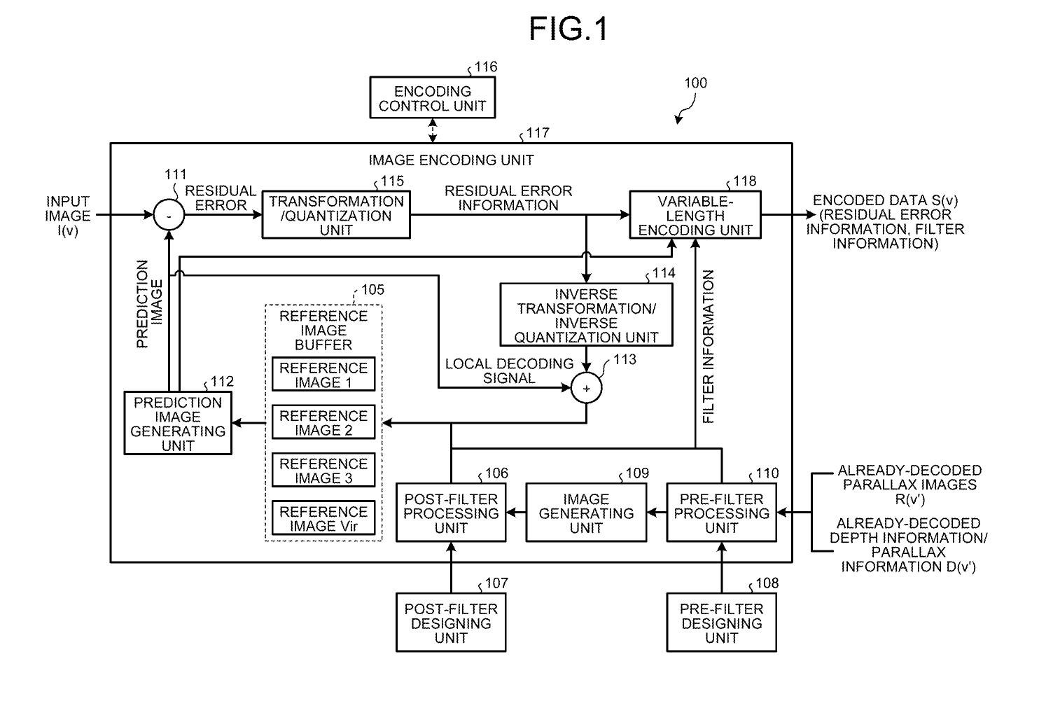

FIG. 1 is a block diagram illustrating a functional configuration of the image encoding device according to the first embodiment. As illustrated in FIG. 1, an image encoding device 100 according to the first embodiment includes an encoding control unit 116, an image encoding unit 117, a pre-filter designing unit 108, and a post-filter designing unit 107.

The encoding control unit 116 controls the image encoding unit 117 in entirety. The pre-filter designing unit 108 generates filter information that is used by a pre-filtering unit 110 (described later). The post-filter designing unit 107 generates filter information that is used by a post-filtering unit 106 (described later). Meanwhile, the details of the pre-filter designing unit 108, the post-filter designing unit 107, and the filter information are given later.

The image encoding unit 117 receives an input image serving as an image to be encoded; implements an image synthesizing technology to generate a parallax image at a viewpoint to be encoded from an already-decoded parallax image at a different viewpoint than the viewpoint of the image to be encoded; encodes the generated parallax image; and outputs the encoded parallax image as encoded data S(v).

As illustrated in FIG. 1, the image encoding unit 117 includes a subtractor 111, a transformation/quantization unit 115, a variable-length encoding unit 118, an inverse transformation/inverse quantization unit 114, an adder 113, a prediction image generating unit 112, the pre-filtering unit 110 functioning as a second filtering unit, an image generating unit 109, the post-filtering unit 106 functioning as a first filtering unit, and a reference image buffer 105.

The image encoding unit 117 receives an input image signal I(v). The subtractor 111 obtains the difference between a prediction image signal, which is generated by the prediction image generating unit 112, and the input image signal I(v); and generates a residual error signal representing that difference.

The transformation/quantization unit 115 performs orthogonal transformation on the residual error signal to obtain a coefficient of orthogonal transformation, as well as quantizes the coefficient of transformation to obtain quantization orthogonal transformation coefficient information. Hereinafter, the quantization orthogonal transformation coefficient information is referred to as residual error information. Herein, for example, discrete cosine transform can be used as the orthogonal transformation. Then, the residual error information (the quantization orthogonal transformation coefficient information) is input to the variable-length encoding unit 118 and the inverse transformation/inverse quantization unit 114.

With respect to the residual error information, the inverse transformation/inverse quantization unit 114 performs an opposite operation to the operation performed by the transformation/quantization unit 115. That is, the inverse transformation/inverse quantization unit 114 performs inverse quantization and inverse orthogonal transformation on the residual error information to regenerate a local decoding signal. The adder 113 then adds the local decoding signal that has been regenerated and the predicted image signal to generate a decoded image signal. The decoded image signal is stored as a reference image in the reference image buffer 105.

Herein, the reference image buffer 105 is a memory medium such as a frame memory. The reference image buffer 105 is used to store the decoded image signal as reference images 1 to 3, as well as to store a synthetic image on which the filtering has been performed by the post-filtering unit 106 (the parallax image at the viewpoint to be encoded) as a reference image Vir. Then, the reference image Vir is input to the prediction image generating unit 112, which generates a prediction image signal from the reference image.

The pre-filtering unit 110 receives an already-decoded parallax image R(v′) at a different viewpoint than the viewpoint of the image to be encoded as well as receives an already-decoded depth information/parallax information D(v′) corresponding to the viewpoint of the parallax image R(v′), and performs pre-filtering with the use of filter information (second filter information) that is designed by the pre-filter designing unit 108. Herein, the filter information contains a filter coefficient, a filter applicability/non-applicability indication which represents whether to perform the filtering process, and the number of pixels for filter application.

Thus, with respect to the already-decoded parallax image R(v′) and the already-decoded depth information/parallax information D(v′) corresponding to the viewpoint of the parallax image R(v′), the pre-filtering unit 110 performs filtering with the use of the filter coefficient and the number of pixels for filter application specified in the filter information. Moreover, the pre-filtering unit 110 sends the filter information to the variable-length encoding unit 118.

The image generating unit 109 generates a parallax image at the viewpoint to be encoded from the information obtained by performing filtering on the already-decoded parallax image at the different viewpoint than the viewpoint of the image to be encoded and the already-decoded depth information/parallax information corresponding to the viewpoint of the already-decoded parallax image. Herein, the parallax image that is generated at the viewpoint as the image to be encoded is referred to as a synthetic image.

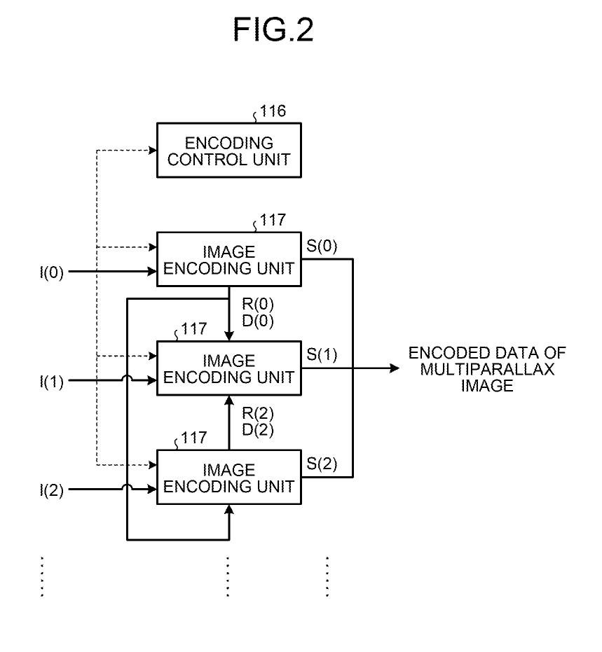

FIG. 2 is a diagram for explaining an example of encoding. In the example illustrated in FIG. 2, if the viewpoint of the image to be encoded is assumed to be “2” and if a different viewpoint is assumed to be “0”; then, as illustrated in FIG. 2, the image generating unit 109 performs 3D warping with the use of a parallax image R(0) at the different viewpoint “0” and with the use of depth information/parallax information D(0) corresponding to the parallax image R(0), and generates a parallax image corresponding to the viewpoint “2” of the image to be encoded.

Then, from a block of (Xⱼ, Yⱼ) of a parallax image at a viewpoint “j” that is used in image synthesis, the image generating unit 109 synthesizes a block of (Xᵢ, Yᵢ) of a synthetic image at a viewpoint “i” of the image to be encoded. Herein, (Xⱼ, Yⱼ) is calculated using Equations (1) and (2) given below.

[u,v,w,]^{T}=RᵢAᵢ⁻¹[xᵢ,yᵢ,1]^{T}zᵢ+Tᵢ (1)

[xⱼ,yⱼ,zⱼ]^{T}=AⱼRⱼ⁻¹{[u,v,w,]^{T}−Tⱼ} (2)

Herein, “R” represents a rotation matrix of the camera; “A” represents an internal camera matrix; and “T” represents a translation matrix of the camera. Moreover, “z” represents a depth value.

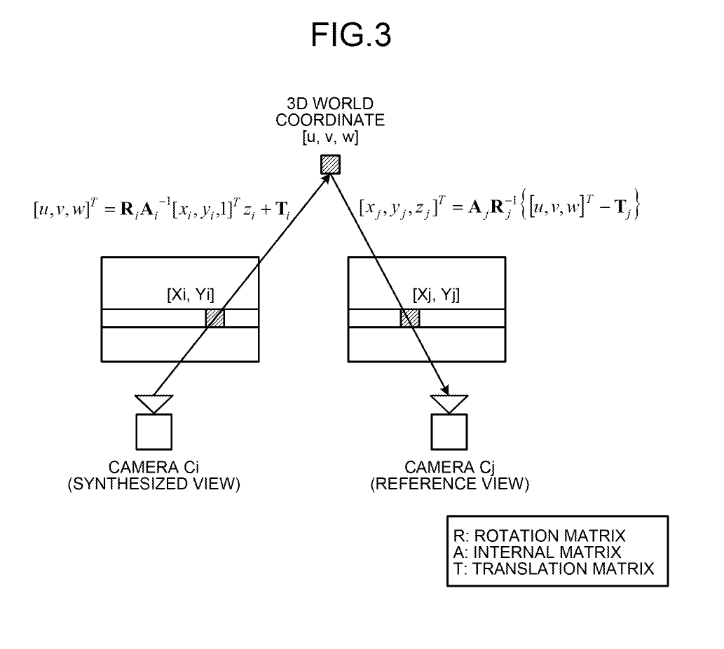

FIG. 3 is an explanatory diagram illustrating an example of image synthesis. It is illustrated in the example in FIG. 3 that a synthetic image [Xᵢ, Yᵢ] at the viewpoint “i” from a camera Cᵢ is generated from a parallax image [Xⱼ, Yⱼ] at the viewpoint “j” from a camera Cⱼ. Herein, [Xⱼ, Yⱼ] is calculated using Equations (1) and (2).

In the example illustrated in FIG. 2, if “1” is assumed to be the viewpoint of the image to be encoded; then, as illustrated in FIG. 2, it becomes possible to generate a synthetic image with the use of information regarding two viewpoints, that is, information regarding the viewpoints of the parallax images R(0) and R(2) and the corresponding depth information/parallax information D(0) and D(2). In that case, the synthetic image generated with the use of R(0) and D(0) as well as the synthetic image generated with the use of R(2) and D(2) can be used as a reference image. Alternatively, an image obtained by taking a weighted mean of the two synthetic images can be considered to be a reference image.

Meanwhile, in a synthetic image generated by means of 3D warping, there may be present an area (hereinafter, “hole”) that cannot be synthesized due to occluded region. In such a case, regarding the hole, the image generating unit 109 can perform an operation of filling up the hole with pixel values of a distant area (an area in background) from among the adjacent areas to the hole. Alternatively, the hole can be left as it is during the operations performed by the image generating unit 109; and, as the filter information referred to by the post-filtering unit 106, the variable-length encoding unit 118 can encode information that specifies the pixel values to be used while filling up the hole. For example, a method can be implemented in which the pixels corresponding to the hole are scanned in sequence, and the information related to the hole is appended by means of Differential Pulse Code Modulation (DPCM). Alternatively, as is the case of in-screen prediction in H.264, a method can be implemented in which the direction of filling up the hole is specified. In that case, at the decoding side too, the occluded region can be filled up in an identical manner according to the encoded information about a filter for filling up the hole.

Returning to the explanation with reference to FIG. 1; with respect to the synthetic image, the post-filtering unit 106 performs post-filtering with the use of the filter information (first filter information) designed by the post-filter designing unit 107. Herein, in the first embodiment, the filter information (the first filter information) generated by the post-filter designing unit 107 includes a filter coefficient, a filter applicability/non-applicability indication, and the number of pixels for filter application.

Thus, with respect to the synthetic image, the post-filtering unit 106 performs filtering with the use of the filter coefficient and the number of pixels for filter application specified in the filter information. Moreover, the post-filtering unit 106 sends the filter information to the variable-length encoding unit 118, and stores the synthetic image on which the filtering has been performed as the reference image Vir in the reference image buffer 105.

The variable-length encoding unit 118 performs variable-length encoding on the residual error information that is output by the transformation/quantization unit 115 and on prediction mode information that is output by the prediction image generating unit 112, and generates the encoded data S(v). Moreover, the variable-length encoding unit 118 performs variable-length encoding on the filter information that is output by the pre-filtering unit 110 and on the filter information that is output by the post-filtering unit 106, and appends the encoded filter information to the encoded data. Thus, the encoded data S(v) generated by the variable-length encoding unit 118 includes the encoded residual error information and the encoded filter information. Then, the variable-length encoding unit 118 outputs the encoded data S(v). Later, the encoded data S(v) is input to an image decoding device via a network or a storage media.

Herein, for example, as is the case of the Skip mode in H.264; if the synthetic image generated by the image generating unit 109 without encoding the residual error information is subjected to the filtering of the post-filtering unit 106 and is output without modification, then appending the information indicating that encoding of the residual error information is skipped to the encoded data S(v) allows the same image at the decoding side to be decoded.

Meanwhile, the post-filter designing unit 107 designs a post-filter. For example, with the use of the synthetic image that is generated by the image generating unit 109 and the input image I(v) to be encoded, the post-filter designing unit 107 sets up Wiener-Hopf equations and obtains the solution. With that, it becomes possible to design a filter that minimizes the square error of the input image I(v) and the synthetic image to which the post-filtering unit 106 has applied the filter.

The filter information (the filter coefficient, the filter applicability/non-applicability indication, and the number of pixels for filter application) related to the filter designed by the post-filter designing unit 107 is input to the post-filtering unit 106 and the variable-length encoding unit 118.

The pre-filter designing unit 108 designs a pre-filter. For example, with the same purpose of minimizing the square error of the synthetic image and the input image I(v) to be encoded, the pre-filter designing unit 108 designs a filter that is to be applied to a local decoding signal of parallax image at a different viewpoint which is used in image synthesis and a local decoding signal of the depth information/parallax information corresponding to the different viewpoint.

The filter information (the filter coefficient, the filter applicability/non-applicability indication, and the number of pixels for filter application) related to the filter designed by the pre-filter designing unit 108 is input to the pre-filtering unit 110 and the variable-length encoding unit 118.

Meanwhile, the method of designing the filters is not limited to the method described in the first embodiment, and it is possible to implement an arbitrary designing method.

Moreover, the method of expressing the filter coefficients is not limited to any particular method. For example, it is possible to implement a method in which one or more filter coefficient sets are set in advance; information specifying the filter coefficient set to be actually used is encoded; and the encoded information is sent to an image decoding device. Alternatively, it is possible to implement a method in which all of the filter coefficients are encoded and sent to an image decoding device side. In that case, regarding the values of filter coefficients, values that are integerized in concert with integer arithmetic can be encoded. Still alternatively, it is possible to implement a method in which the filter coefficients are sent by means of prediction. Regarding the method of prediction, for example, a filter coefficient can be predicted from the coefficients of adjacent pixels with the use of the spatial correlation of filter coefficients; and the residual error can be encoded. Alternatively, the temporal correlation of filter coefficients can be taken into account to calculate a difference from a reference filter coefficient set, and the residual error can be encoded.

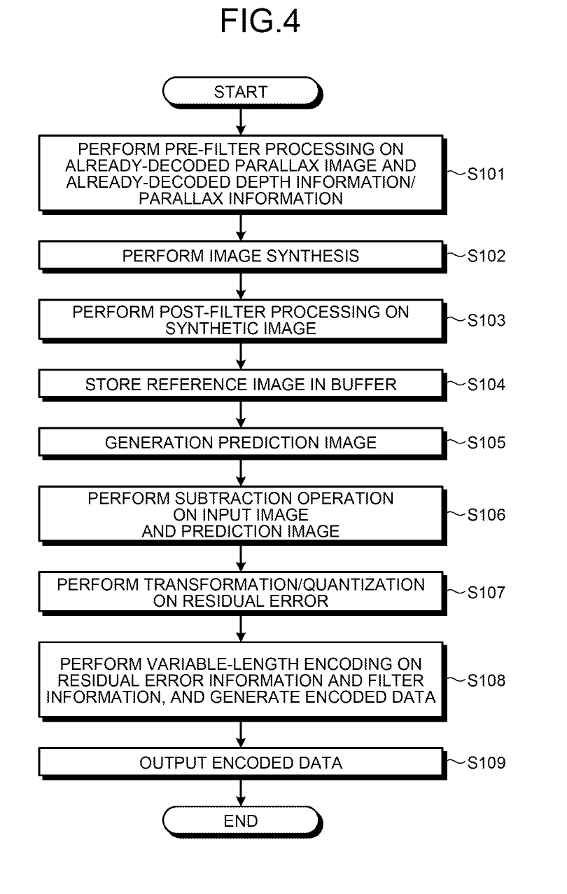

Explained below is an encoding process performed by the image encoding device that is configured in the manner described above according to the first embodiment. FIG. 4 is a flowchart for explaining a sequence of operations performed during the encoding process according to the first embodiment.

Firstly, the pre-filtering unit 110 receives an already-decoded parallax image R(v′) at a different viewpoint as well as receives already-decoded depth information/parallax information D(v′) corresponding to the different viewpoint, and applies the pre-filter designed by the pre-filter designing unit 108 to the received information (Step S101).

Then, the image generating unit 109 performs image synthesis (Step S102). Specifically, the image generating unit 109 generates a parallax image (synthetic image) at the viewpoint to be encoded, from the already-decoded parallax image R(v′) at a different viewpoint and the already-decoded depth information/parallax information D(v′) corresponding to the different viewpoint after the pre-filter is applied thereto. Subsequently, to that synthetic image, the post-filtering unit 106 applies the post-filter that is designed by the post-filter designing unit 107 (Step S103); and stores that synthetic image to which the post-filter has been applied, as the reference image Vir in the reference image buffer 105 (Step S104).

The prediction image generating unit 112 obtains the reference image Vir from the reference image buffer 105 and generates a prediction image (Step S105). Then, the subtractor 111 performs a subtraction operation on the input image I(v) to be encoded, and the reference image Vir; and calculates a residual error signal (Step S106). Subsequently, the transformation/quantization unit 115 performs orthogonal transformation on the residual error signal and obtains a coefficient of orthogonal transformation, as well as quantizes the coefficient of orthogonal transformation to obtain residual error information that is quantization orthogonal transformation coefficient information (Step S107).

Then, the variable-length encoding unit 118 performs variable-length encoding on the residual error information and the filter information that is input from the pre-filtering unit 110 and the post-filtering unit 106, and generates the encoded data S(v) (Step S108). Subsequently, the variable-length encoding unit 118 outputs the encoded data S(v) (Step S109).

In this way, in the first embodiment, the parallax image (the synthetic image) at the viewpoint of the image to be encoded is generated by applying a pre-filter to the already-decoded parallax image R(v′) at the different viewpoint and the already-decoded depth information/parallax information D(v′) corresponding to the different viewpoint. Then, a post-filter is applied to the generated synthetic image so as to obtain the reference image Vir; and a prediction image is generated from the reference image Vir. Subsequently, the parallax image to be encoded is encoded using the prediction image. As a result, it becomes possible to enhance the image quality as well as to enhance the encoding efficiency.

Thus, in the first embodiment, by applying a pre-filter to the already-decoded parallax image R(v′) and the already-decoded depth information/parallax information D(v′), it becomes possible to reduce the difference in color shades among the viewpoints of the parallax images and to reduce the synthesis distortion caused due to coding distortion occurring in the parallax images. Particularly, regarding the depth information, it may happen that the accuracy of the depth estimation is not sufficient. On top of that, coding distortion gets applied due to encoding. For that reason, it can be thought that the depth information has a large impact on the synthesis distortion. In that regard, in the first embodiment, prior to the image synthesizing process performed by the image generating unit 109, the pre-filter is applied to the already-decoded parallax image R(v′) and the already-decoded depth information/parallax information D(v′). As a result, it becomes possible to prevent the synthesis distortion from occurring.

Meanwhile, the synthetic image that is generated by the image generating unit 109 is synthesized from a parallax image at a different viewpoint. Therefore, parallax images having different color shades get synthesized. That may result in a greater distortion in the synthetic image. Moreover, because of the estimation error in the depth information or because of the effect of occluded region, there may be an increase in the error between the original image and the synthetic image. Particularly, regarding occluded region, in principle, it is not possible for image synthesis to reconstruct an occluded region. Therefore, there occurs an increase in the error between the original image and the synthetic image. In that regard, in the first embodiment, in order to ensure that such an area is correctly reproduced; the post-filtering is performed with the use of the filter information, so that it becomes possible to reduce the error from the parallax image at the corresponding viewpoint. Then, the filter information is appended to the encoded data S(v), so that it becomes possible to reduce the distortion caused due to the image synthesis.

Meanwhile, the image encoding device 100 according to the first embodiment is not limited to have the configuration described above in the first embodiment. Alternatively, for example, the configuration can be such that only one of the pre-filtering unit 110 and the post-filtering unit 106 is used. In that case, the filter information related to only the filter to be used needs to be appended to the encoded data S(v).

Moreover, in the image encoding device 100 according to the first embodiment, the input image I(v) is not limited to image signals of multiple parallaxes. Alternatively, for example, as is the case of Multi-view Video plus Depth in which parallax images of multiple parallaxes and the corresponding depth information of multiple parallaxes are encoded; in the case of encoding depth information of multiple parallaxes, the configuration can be such that the depth information/parallax information is received as the input image I(v).

### Second Embodiment

In a second embodiment, the explanation is given about an image decoding device that decodes the encoded data S(v) sent by an image encoding device.

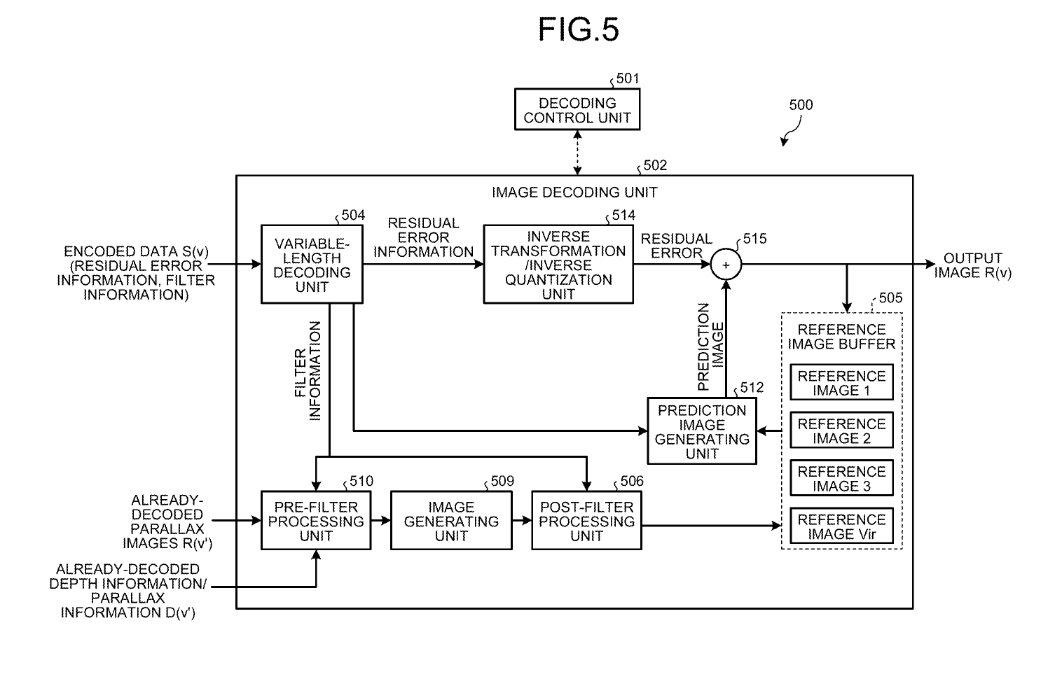

FIG. 5 is a block diagram illustrating a functional configuration of an image decoding device according to the second embodiment. As illustrated in FIG. 5, an image decoding device 500 according to the second embodiment includes a decoding control unit 501 and an image decoding unit 502. The decoding control unit 501 controls the image decoding unit 502 in entirety.

From the image encoding device according to the first embodiment, the image decoding unit 502 receives the encoded data S(v), which is to be decoded, via a network or a storage media. Then, the image decoding unit 502 generates a parallax image at the viewpoint to be decoded from the information based on a parallax image at a different viewpoint than the viewpoint of the image to be decoded. Herein, the encoded data S(v) that is to be decoded includes codes for prediction mode information, residual error information, and filter information.

As illustrated in FIG. 5, the image decoding unit 502 includes a variable-length decoding unit 504, an inverse transformation/inverse quantization unit 514, an adder 515, a prediction image generating unit 512, a pre-filtering unit 510, an image generating unit 509, a post-filtering unit 506, and a reference image buffer 505. Herein, the variable-length decoding unit 504, the inverse transformation/inverse quantization unit 514, and the adder 515 function as a decoding unit.

The variable-length decoding unit 504 receives the encoded data S(v); performs variable-length decoding on the encoded data S(v); and obtains the prediction mode information, the residual error information (quantization orthogonal transformation coefficient information), and the filter information included in the encoded data S(v). The variable-length decoding unit 504 outputs the decoded residual error information to the inverse transformation/inverse quantization unit 514, and outputs the decoded filter information to the pre-filtering unit 510 and the post-filtering unit 506. Herein, the details of the filter information are identical to the details given in the first embodiment. That is, the filter information includes a filter coefficient, a filter applicability/non-applicability indication, and the number of pixels for filter application.

The inverse transformation/inverse quantization unit 514 performs inverse quantization and inverse orthogonal transformation on the residual error information, and outputs a residual error signal. The adder 515 generates a decoded image signal by adding the residual error signal and the prediction image signal that is generated by the prediction image generating unit 512, and then outputs that decoded image signal as an output image signal R(v). Meanwhile, the decoded image signal is stored as the reference images 1 to 3 in the reference image buffer 505.

The reference image buffer 505 is a memory medium such as a frame memory and is used to store the decoded image signal as a reference image as well as to store a synthetic image that is output by the post-filtering unit 506 (described later) as the reference image Vir.

The prediction image generating unit 512 generates a prediction image signal from the reference image stored in the reference image buffer 505.

Herein, for example, as is the case of the Skip mode in H.264; if the encoded data S(v) includes the information indicating that encoding of the residual error signal is skipped, then the reference images stored in the reference image buffer 505 are output without modification. As a result, it becomes possible to decode the same image as the image encoding device 100.

The pre-filtering unit 510 receives an already-decoded parallax image R(v′) at a different viewpoint than the viewpoint to be decoded as well as receives already-decoded depth information/parallax information D(v′) corresponding to the viewpoint of the parallax image R(v′), and performs pre-filtering with the use of filter information (second filter information) that is sent by the variable-length decoding unit 504. Herein, the details of filtering (pre-filtering) performed by the pre-filtering unit 510 are identical to the filtering performed by the pre-filtering unit 110 according to the first embodiment.

The image generating unit 509 generates a parallax image at the viewpoint to be decoded from the information obtained by performing pre-filtering on the already-decoded parallax image R(v′) at a different viewpoint than the viewpoint of the image to be decoded as well as the already-decoded depth information/parallax information D(v′) corresponding to the viewpoint of the parallax image R(v′). Herein, the parallax image that is generated at the viewpoint to be decoded is referred to as a synthetic image. Meanwhile, the details of the synthetic image generation operation performed by the image generating unit 509 are identical to the operation performed by the image generating unit 109 according to the first embodiment.

The post-filtering unit 506 performs post-filtering on the synthetic image with the use of filter information (first filter information) sent by the variable-length decoding unit 504. Then, the post-filtering unit 506 stores the synthetic image on which the filtering has been performed, as the reference image Vir in the reference image buffer 505. That reference image Vir is later referred to by the prediction image generating unit 512 while generating a prediction image.

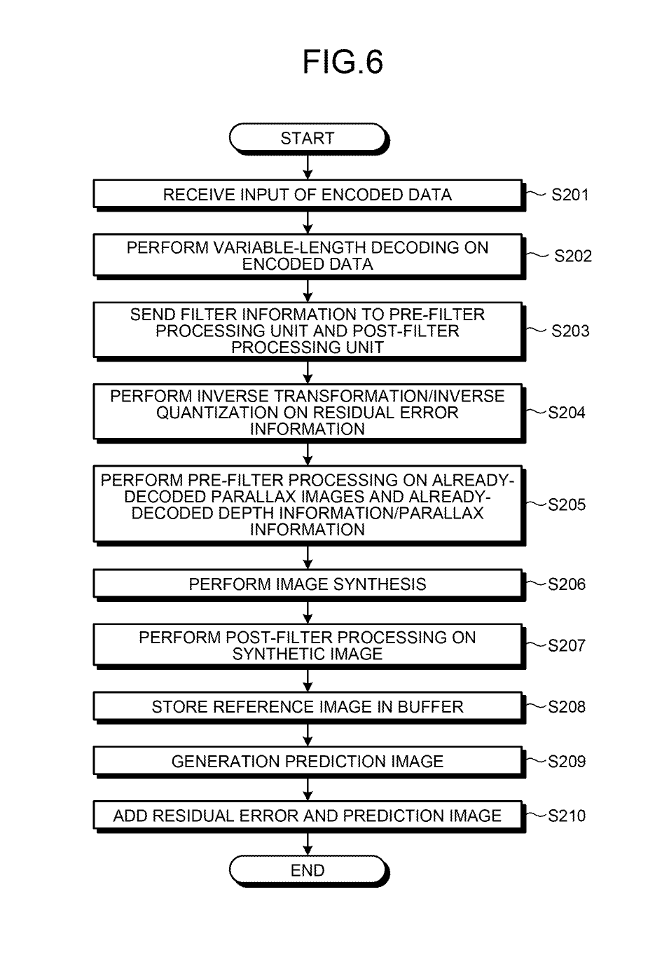

Explained below is a decoding process performed by the image decoding device 500 that is configured in the manner described above according to the second embodiment. FIG. 6 is a flowchart for explaining a sequence of operations performed during the decoding process according to the second embodiment.

Firstly, from the image encoding device 100, the variable-length decoding unit 504 receives the encoded data S(v), which is to be decoded, via a network or a storage media (Step S201). Then, from the encoded data S(v), the variable-length decoding unit 504 extracts the residual error information and the filter information included in the encoded data S(v) (Step S202). Subsequently, the variable-length decoding unit 504 sends the filter information to the pre-filtering unit 510 and the post-filtering unit 506 (Step S203).

The decoded residual error information is sent to the inverse transformation/inverse quantization unit 514. Then, the inverse transformation/inverse quantization unit 514 performs inverse quantization and inverse orthogonal transformation on the residual error information to output a residual error signal (Step S204).

The pre-filtering unit 510 receives the already-decoded parallax image R(v′) at a different viewpoint than the viewpoint of the image to be decoded as well as receives the already-decoded depth information/parallax information D(v′) corresponding to the viewpoint of the parallax image R(v′), and applies a pre-filter using filter information that is sent by the variable-length decoding unit 504 (Step S205).

Then, the image generating unit 509 performs image synthesis (Step S206). Specifically, the image generating unit 509 generates a parallax image at the viewpoint to be decoded from the information obtained by performing pre-filtering on the already-decoded parallax image R(v′) as well as the already-decoded depth information/parallax information D(v′). The generated parallax image is considered to be a synthetic image.

Subsequently, with respect to the synthetic image, the post-filtering unit 506 applies a post-filter with the use of the filter information that is sent by the variable-length decoding unit 504 (Step S207). Then, the post-filtering unit 506 stores the synthetic image to which the post-filter has been applied, as the reference image Vir in the reference image buffer 505 (Step S208).

Then, the decoded prediction mode information is sent to the prediction image generating unit 512. Subsequently, the prediction image generating unit 512 obtains the reference image Vir from the reference image buffer 505 and generates a prediction image signal according to the prediction mode information (Step S209). Then, the adder 515 generates a decoded image signal by adding the residual error signal, which is output by the inverse transformation/inverse quantization unit 514, and the prediction image signal, which is generated by the prediction image generating unit 512; and then outputs that decoded image signal as the output image signal R(v) (Step S210).

In this way, in the second embodiment, a parallax image (synthetic image) at the viewpoint of the image to be decoded is generated by applying a pre-filter to the already-decoded parallax image R(v′) at a different viewpoint and the already-decoded depth information/parallax information D(v′) corresponding to the different viewpoint. Then, a post-filter is applied to the generated synthetic image so as to obtain the reference image Vir; and a prediction image is generated from the reference image Vir. Subsequently, the parallax image to be decoded is generated using the prediction image. As a result, it becomes possible to enhance the image quality as well as to enhance the encoding efficiency.

Thus, in the second embodiment, in an identical manner to the first embodiment, prior to the image synthesis process performed by the image generating unit 509, a pre-filter is applied to the already-decoded depth information/parallax information D(v′). That makes it possible to prevent the synthesis distortion from occurring.

Moreover, in the second embodiment, in an identical manner to the first embodiment, the post-filtering is performed using the filter information so as to reduce the error from the parallax image at the corresponding viewpoint. Then, the filter information is appended to the encoded data S(v), so that it becomes possible to reduce the distortion caused due to the image synthesis.

### Third Embodiment

In a third embodiment, the explanation is given about an image decoding device that, from multiparallax images at N (N≧1) viewpoints, decodes multiparallax images at M (M>N) viewpoints. In an identical manner to the second embodiment, the image decoding device according to the third embodiment includes a decoding control unit (not illustrated) and an image decoding unit (not illustrated). Moreover, in an identical manner to the second embodiment, the decoding control unit controls the image decoding unit in entirety.

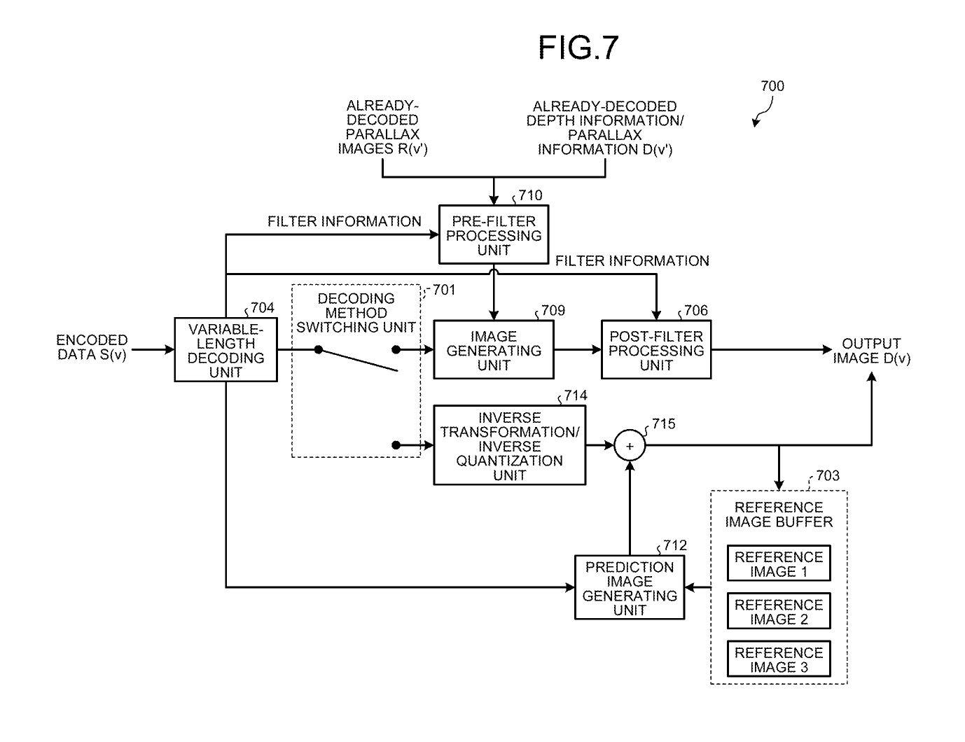

FIG. 7 is a block diagram illustrating a functional configuration of an image decoding unit 700 of the image decoding device according to the third embodiment.

From the image encoding device 100 according to the first embodiment; the image decoding unit 700 receives the encoded data S(v), which is to be decoded, via a network or a storage media. Then, the image decoding unit 700 generates a parallax image at the viewpoint of the image to be decoded from the information based on the parallax images at a different viewpoint than the viewpoint of the image to be decoded. Herein, similar to the second embodiment, the encoded data S(v), which is to be decoded, includes codes for residual error information and filter information.

As illustrated in FIG. 7, the image decoding unit 700 according to the third embodiment includes a variable-length decoding unit 704, an inverse transformation/inverse quantization unit 714, an adder 715, a prediction image generating unit 712, a pre-filtering unit 710, an image generating unit 709, a post-filtering unit 706, and a reference image buffer 703.

Herein, the variable-length decoding unit 704, the inverse transformation/inverse quantization unit 714, and the pre-filtering unit 710 perform identical functions to the functions explained in the second embodiment.

In the third embodiment, a decoding method switching unit 701 is additionally disposed. Moreover, the synthetic image to which a post-filter is applied by the post-filtering unit 706 is not stored in the reference image buffer 703.

The decoding method switching unit 701 switches the decoding method between a first decoding method and a second decoding method on the basis of the viewpoint of the image to be decoded. In the first decoding method, the encoded data S(v) is decoded using the already-decoded parallax image R(v′) at a different viewpoint than the viewpoint of the image to be decoded as well as using the already-decoded depth information/parallax information D(v′) corresponding to the viewpoint of the parallax image R(v′).

In the second decoding method, the encoded data S(v) is decoded without using the already-decoded parallax image R(v′) and the already-decoded depth information/parallax information D(v′).

When the decoding method switching unit 701 switches the decoding method to the first decoding method, the image generating unit 709 generates a synthetic image (a parallax image at the viewpoint of the image to be decoded) from the already-decoded parallax image R(v′) and the already-decoded depth information/parallax information D(v′).

Moreover, when the decoding method switching unit 701 switches the decoding method to the first decoding method, the post-filtering unit 706 performs post-filtering on the synthetic image, which is generated by the image generating unit 709, using the filter information included in the encoded data S(v); and outputs the synthetic image on which the post-filtering has been performed as an output image D(v).

When the decoding method switching unit 701 switches the decoding method to the second decoding method, the prediction image generating unit 712 generates a prediction image signal without using the synthetic image as the reference image.

Moreover, when the decoding method is switched to the second decoding method, the adder 715 adds the decoded, encoded data S(v) and the prediction image signal, and generates an output image signal. Then, the output image signal is stored in the reference image buffer 703.

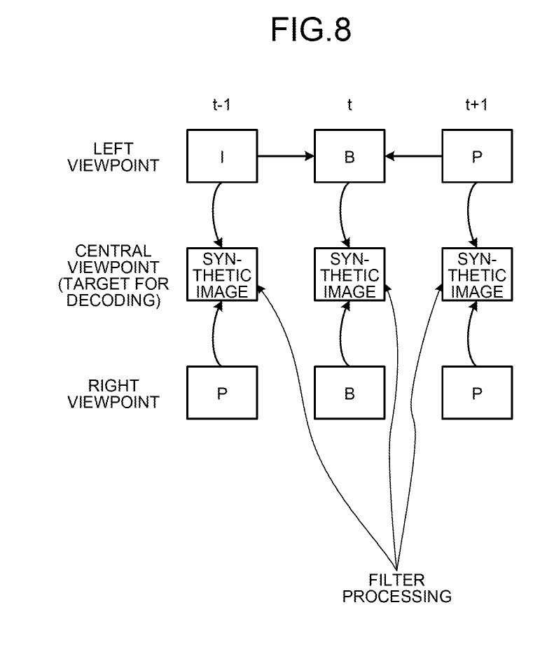

FIG. 8 is a diagram illustrating an example of encoding a multiparallax image using a synthetic image. For example, as illustrated in FIG. 8, in the case decoding a parallax image at the left viewpoint or a parallax image at the right viewpoint; the decoding method switching unit 701 switches the decoding method to the second decoding method. Then, the image decoding unit 700 adds the prediction image signal, which is generated by the prediction image generating unit 712, to the residual error signal, which is obtained by the variable-length decoding unit 704 and the inverse transformation/inverse quantization unit 714; and decodes the parallax image at the target viewpoint.

Moreover, as illustrated in FIG. 8, in the case of decoding a parallax image at the central viewpoint, the decoding method switching unit 701 switches the decoding method to the first decoding method. Then, the image decoding unit 700 generates a parallax image at the central viewpoint by performing image synthesis on the already-decoded parallax image at the left viewpoint and the already-decoded parallax image at the right viewpoint. Then, in an identical manner to the second embodiment, the image decoding unit 700 decodes the parallax image at the central viewpoint by performing post-filtering according to the filter information obtained by the variable-length decoding unit 704.

In this way, in the third embodiment, the decoding method is switched depending on the viewpoint of the image to be decoded. Hence, in response to a viewpoint, it becomes possible to further enhance the image quality as well as to enhance the encoding efficiency.

Meanwhile, the image decoding device 500 according to the second embodiment and the image decoding unit 700 according to the third embodiment are not limited to have the configurations described in the respective embodiments. Alternatively, for example, the configurations can be such that only one of the pre-filtering unit 510 and the post-filtering unit 506 is used, and only one of the pre-filtering unit 710 and the post-filtering unit 706 is used. In that case, the filter information related to only the filter to be used can be appended to the encoded data S(v).

Meanwhile, in the first to third embodiments, depending on the feature of local areas in an image, switching between pluralities of filters is performed for each area. Alternatively, the same holds true for a case when switching is performed between application/non-application of a single filter. Thus, the configuration can be such that the filter information containing a filter coefficient, a filter applicability/non-applicability indication, and the number of pixels for filter application can be switched in the units of pictures, slices, or blocks.

In this case, in the image encoding device 100; the configuration can be such that, for each processing unit for which the filter is switched, the filter information is appended to the encoded data S(v). Moreover, the image decoding device 500 and the image decoding unit 700 can be configured to implement filtering according to the filter information appended to the encoded data S(v).

In the first to third embodiments, filtering can also be performed in a case in which the already-decoded parallax image at a different viewpoint and the already-decoded depth information/parallax information corresponding to the different viewpoint are input equivalent to N number of viewpoints (N≧1) to the pre-filtering units 110, 510, and 710, respectively. In that case, the filter information used in the pre-filtering units 110, 510, and 710 is not limited to the use of a common filter with respect to each set of data. Alternatively, for example, it is possible to apply different filters to the parallax images and the depth information. Still alternatively, the configuration can be such that a different filter can be applied to each viewpoint. In that case, regarding each filter that is applied, the filter information is encoded and sent to the image decoding device 500 and the image decoding unit 700.

Meanwhile, regarding the filter information among the filters, it is also possible to implement a method in which the correlation between the filters is used to predict the filter information from other filters. Moreover, the configuration can be such that the filters are applied to parallax images or to depth information/parallax information.

In the configuration of the image encoding unit 117 illustrated in FIG. 2, the filter applied by each image encoding unit 117 need not be limited to a common filter. That is, each image encoding unit 117 can apply a different filter.

Meanwhile, an image encoding program executed in the image encoding device 100 according to the first embodiment as well as an image decoding program executed in the image decoding device 500 according to the second embodiment and the image decoding unit 700 according to the third embodiment is stored in advance in a ROM or the like.

Alternatively, the image encoding program executed in the image encoding device 100 according to the first embodiment as well as the image decoding program executed in the image decoding device 500 according to the second embodiment and the image decoding unit 700 according to the third embodiment can be recorded in the form of an installable or executable file on a computer-readable recording medium such as a CD-ROM, a flexible disk (FD), a CD-R, or a digital versatile disk (DVD), as a computer program product.

Still alternatively, the image encoding program executed in the image encoding device 100 according to the first embodiment as well as the image decoding program executed in the image decoding device 500 according to the second embodiment and the image decoding unit 700 according to the third embodiment can be saved in a downloadable manner on a computer connected to a network such as the Internet. Still alternatively, the image encoding program executed in the image encoding device 100 according to the first embodiment as well as the image decoding program executed in the image decoding device 500 according to the second embodiment and the image decoding unit 700 according to the third embodiment can be distributed over a network such as the Internet.

The image encoding program executed in the image encoding device 100 according to the first embodiment contains modules for each of the abovementioned constituent elements (the subtractor, the transformation/quantization unit, the variable-length encoding unit, the inverse transformation/inverse quantization unit, the adder, the prediction image generating unit, the pre-filtering unit, the image generating unit, and the post-filtering unit). In practice, a CPU (processor) reads the image encoding program from the ROM mentioned above and runs it so that the image encoding program is loaded in a main memory device. As a result, the module for each of the subtractor, the transformation/quantization unit, the variable-length encoding unit, the inverse transformation/inverse quantization unit, the adder, the prediction image generating unit, the pre-filtering unit, the image generating unit, and the post-filtering unit is generated in the main memory device. Meanwhile, alternatively, the above-mentioned constituent elements of the image encoding device 100 can be configured with hardware such as circuits.

The image decoding program executed in the image decoding device 500 according to the second embodiment and the image decoding unit 700 according to the third embodiment contains modules for each of the abovementioned constituent elements (the variable-length decoding unit, the inverse transformation/inverse quantization unit, the adder, the prediction image generating unit, the pre-filtering unit, the image generating unit, and the post-filtering unit). In practice, a CPU (processor) reads the image encoding program from the ROM mentioned above and runs it so that the image decoding program is loaded in a main memory device. As a result, the module for each of the variable-length decoding unit, the inverse transformation/inverse quantization unit, the adder, the prediction image generating unit, the pre-filtering unit, the image generating unit, and the post-filtering unit is generated in the main memory device. Meanwhile, alternatively, the abovementioned constituent elements of the image decoding device 500 and the image decoding unit 700 can be configured with hardware such as circuits.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image encoding device comprising:
an image generating unit configured to generate a first parallax image corresponding to a first viewpoint of an image to be encoded, with the use of at least one of depth information and parallax information of a second parallax image corresponding to a second viewpoint being different than the first viewpoint;
a first filtering unit configured to perform filtering on the first parallax image based on first filter information;
a prediction image generating unit configured to generate a prediction image with a reference image, the reference image being the first parallax image on which the filtering has been performed; and
an encoding unit configured to generate encoded data from the image and the prediction image.

2. The device according to claim 1, wherein the encoding unit further encodes the first filter information and appends the encoded first filter information to the encoded data.

3. The device according to claim 2, further comprising a second filtering unit configured to perform filtering on the second parallax image on the basis of second filter information, wherein
the image generating unit generates the first parallax image based on the second parallax image on which the filtering has been performed, and
the encoding unit further encodes the second filter information and appends the encoded second filter information to the encoded data.

4. The device according to claim 3, wherein each of the first filter information and the second filter information includes a filter coefficient, a filter applicability/non-applicability indication, and the number of pixels for filter application.

5. The image encoding device according to claim 1, wherein the image generating unit generates the first parallax image on the basis of the second parallax image being already decoded and at least one of already-decoded depth information and already-decoded parallax information corresponding to the second viewpoint.

6. An image decoding device comprising:
an image generating unit configured to generate a first parallax image corresponding to a first viewpoint of an image to be decoded, with the use of at least one of depth information and parallax information of a second parallax image corresponding to a second viewpoint being different than the first viewpoint;
a first filtering unit configured to perform filtering on the first parallax image based on first filter information;
a prediction image generating unit configured to generate a prediction image with a reference image, the reference image being the first parallax image on which the filtering has been performed; and
a decoding unit configured to decode input encoded data and generate an output image from the decoded, encoded data and the prediction image.

7. The device according to claim 6, wherein
the encoded data includes the filter information that has been encoded, and
the decoding unit receives the encoded data from an image encoding device, and decodes the filter information included in the encoded data.

8. The device according to claim 7, further comprising a second filtering unit configured to perform filtering on the second parallax image on the basis of second filter information, wherein
the encoded data includes the second filter information that has been encoded,
the decoding unit decodes the second filter information included in the encoded data, and
the image generating unit generates the first parallax image based on the second parallax information on which the filtering has been performed.

9. The device according to claim 8, wherein each of the first filter information and the second filter information includes a filter coefficient, a filter applicability/non-applicability indication, and the number of pixels for filter application.

10. The device according to claim 6, wherein the image generating unit generates the first parallax image on basis of the second parallax image being already-decoded and at least one of already-decoded depth information and already-decoded parallax information corresponding to the second viewpoint.

11. The device according to claim 6, further comprising a switching unit configured to switch, between a first decoding method and a second decoding method based on the first viewpoint, the encoded data is decoded using at least one of depth information and parallax information of the second parallax image in the first decoding method, the encoded data is decoded without using the depth information or the parallax information in the second decoding method, wherein
in the first decoding method, the image generating unit generates the first parallax image using at least one of the depth information and the parallax information,
in the first decoding method, the first filtering unit performs filtering on the first parallax image that is generated by the image generating unit, on the basis of the first filter information, and outputs the first parallax image on which the filtering has been performed as the output image,
in the second decoding method, the prediction image generating unit generates the prediction image without using the first parallax image as a reference image, and
in the second decoding method, the decoding unit generates an output image based on the decoded, encoded data and the prediction image.

12. An image encoding method comprising:
generating a first parallax image corresponding to a first viewpoint of an image to be encoded, with the use of at least one of depth information and parallax information of a second parallax image corresponding to a second viewpoint being different than the first viewpoint;
performing filtering on the first parallax image based on first filter information;
generating a prediction image with a reference image, the reference image being the first parallax image on which the filtering has been performed; and
generating encoded data from the image and the prediction image.

13. An image decoding method comprising:
generating a first parallax image corresponding to a first viewpoint of an image to be decoded, with the use of at least one of depth information and parallax information of a second parallax image corresponding to a second viewpoint being different than the first viewpoint;
performing filtering on the first parallax image based on first filter information;
generating a prediction image with a reference image, the reference image being the first parallax image on which the filtering has been performed; and
decoding input encoded data and generate an output image from the decoded, encoded data and the prediction image.

14. A computer program product comprising a computer-readable medium containing a program executed by a computer, the program causing the computer to execute:
generating a first parallax image corresponding to a first viewpoint of an image to be encoded, with the use of at least one of depth information and parallax information of a second parallax image corresponding to a second viewpoint being different than the first viewpoint;
performing filtering on the first parallax image based on first filter information;
generating a prediction image with a reference image, the reference image being the first parallax image on which the filtering has been performed; and
generating encoded data from the image and the prediction image.

15. A computer program product comprising a computer-readable medium containing a program executed by a computer, the program causing the computer to execute:
generating a first parallax image corresponding to a first viewpoint of an image to be decoded, with the use of at least one of depth information and parallax information of a second parallax image corresponding to a second viewpoint being different than the first viewpoint;
performing filtering on the first parallax image based on first filter information;
generating a prediction image with a reference image, the reference image being the first parallax image on which the filtering has been performed; and
decoding input encoded data and generate an output image from the decoded, encoded data and the prediction image.
